(19) United States
(12) Patent Application Publication
(10) Pub. No.: US 2015/0116357 A1
(43) Pub. Date: Apr. 30, 2015

(54) DISPLAY DEVICE

(71) Applicant: Kabushiki Kaisha Toshiba, Minato-ku (JP)

(72) Inventors: Akihisa MORIYA, Kawasaki (JP); Tomoya Tsuruyama, Kawasaki (JP); Aira Hotta, Kawasaki (JP); Takashi Sasaki, Yokohama (JP); Haruhiko Okumura, Fujisawa (JP); Yoshiyuki Kokojima, Yokohama (JP); Masahiro Baba, Yokohama (JP)

(73) Assignee: Kabushiki Kaisha Toshiba, Minato-ku (JP)

(21) Appl. No.: 14/462,879

(22) Filed: Aug. 19, 2014

(30) Foreign Application Priority Data
Oct. 31, 2013 (JP) 2013-226668

(51) Int. Cl. G02B 27/01; G06F 3/01; G06T 19/00

(52) U.S. Cl. CPC G02B 27/0172; G06T 19/006; G06F 3/013; G02B 2027/0138; G02B 2027/0178
USPC 345/633

(57) ABSTRACT

According to one embodiment, a display device includes a light emitter, a reflector, a virtual image position controller, and a holder. The light emitter emits light flux including an image. The reflector is in front of an eye of a viewer. The reflector is partially reflective and partially transparent and reflects the light flux toward the eye and form a virtual image. The virtual image position controller controls a position of the virtual image. The holder holds the reflector. The virtual image position controller sets the position of the virtual image to a first position on a line connecting the eye and a background object in front of the eye and subsequently moves the position of the virtual image to a second position on the line that lies closer to the reflector than the first position.

### CROSS-REFERENCE TO RELATED APPLICATIONS

This application is based upon and claims the benefit of priority from Japanese Patent Application No. 2013-226668, filed on Oct. 31, 2013; the entire contents of which are incorporated herein by reference.

### FIELD

Embodiments described herein relate generally to a display device.

### BACKGROUND

There is a display device (a Head Mounted Display (HMD)) that is mounted to the head of a viewer. It is desirable to improve the ease of viewing in such a display device.

### BRIEF DESCRIPTION OF THE DRAWINGS

FIG. 1 is a schematic view showing a display device according to an embodiment;

FIG. 2 is a schematic perspective view showing the display device according to the embodiment;

FIG. 3 is a graph showing the experimental results relating to the display device; and

FIG. 4 is a flowchart showing the operations of the display device according to the embodiment.

### DETAILED DESCRIPTION

According to one embodiment, a display device includes a light emitter, a reflector, a virtual image position controller, and a holder. The light emitter emits light flux including an image. The reflector is in front of an eye of a viewer. The reflector is partially reflective and partially transparent and reflects the light flux toward the eye and form a virtual image. The virtual image position controller controls a position of the virtual image.

The holder holds the reflector. The virtual image position controller sets the position of the virtual image to a first position on a line connecting the eye and a background object in front of the eye and subsequently moves the position of the virtual image to a second position on the line that lies closer to the reflector than the first position.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions. In the drawings and the specification of the application, components similar to those described in regard to a drawing thereinabove are marked with like reference numerals, and a detailed description is omitted as appropriate.

### Embodiment

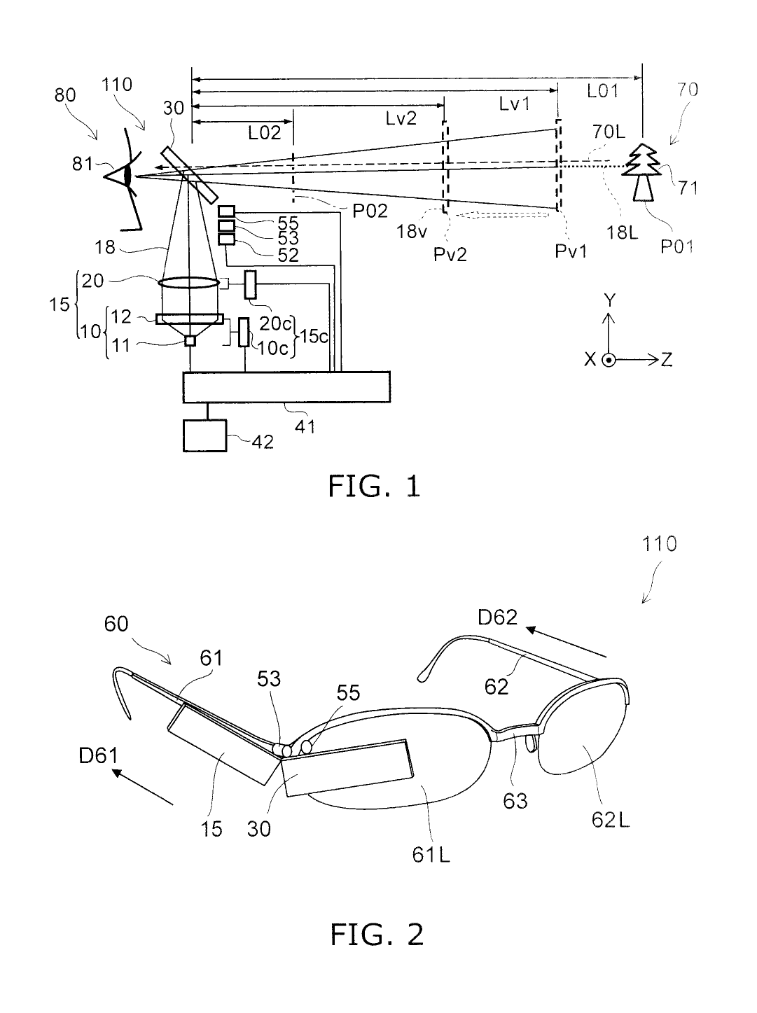

FIG. 1 is a schematic view illustrating a display device according to an embodiment.

FIG. 2 is a schematic perspective view illustrating the display device according to the embodiment. As shown in FIG. 1, the display device 110 according to the embodiment includes a light emitter 15 and a reflector 30.

The light emitter 15 emits light flux 18. The light flux 18 includes an image. The image includes a display object.

The reflector 30 is provided between a background 70 and an eye 81 of a viewer 80. The background 70 includes an object 71 in front of the eye 81. The reflector 30 transmits light 70L from the background 70 to be incident on the eye 81. The reflector 30 reflects the light flux 18 emitted from the light emitter 15 toward the eye 81. The reflector 30 is, for example, transmissive and reflective. The reflector 30 includes, for example, a combiner. The reflector 30 is disposed in front of the eye 81 of the viewer 80.

As shown in FIG. 2, the display device 110 further includes a holder 60. The holder 60 regulates the relative positions of the eye 81 and the reflector 30. In the example, the holder 60 includes a first holder 61, a second holder 62, and a connection unit 63. The configurations of the first holder 61 and the second holder 62 are, for example, the temples of glasses. The first holder 61 extends along a first extension direction D61. The second holder 62 extends along a second extension direction D62. The second extension direction D62 is aligned with the first extension direction D61. The second extension direction D62 may or may not be parallel to the first extension direction D61. The connection unit 63 connects one end of the first holder 61 to one end of the second holder 62. In the example, a first lens unit 61L and a second lens unit 62L are provided in the holder 60. These lens units are held by the connection unit 63.

For example, the first holder 61 and the second holder 62 contact the head of the viewer 80. The first holder 61 and the second holder 62 are disposed on the ears of the viewer 80.

The light emitter 15 and the reflector 30 are held by the holder 60. Thereby, the relative positions of the eye 81 and the reflector 30 are regulated.

As illustrated in FIG. 2, an information acquirer 53 and a sensor 55 are further provided in the example. The sensor 55 is configured to sense an eye gaze (viewing direction) of the viewer 80. The sensor 55 is an eye gaze sensor. The information acquirer 53 and the sensor 55 are held by, for example, the holder 60. The information acquirer 53 and the sensor 55 may be held by, for example, at least one selected from the light emitter 15 and the reflector 30. The information acquirer 53 and the sensor 55 are described below.

As illustrated in FIG. 1, the light emitter 15 includes, for example, an image light generator 10 and an optical unit 20. The image light generator 10 emits the light flux 18. The image light generator 10 includes, for example, a light source unit 11 and an image generation unit 12. The light source unit 11 emits the light. The light source unit 11 includes, for example, a semiconductor light emitting element, etc. The light is incident on the image generation unit 12. The image generation unit 12 includes multiple optical switches. The image generation unit 12 includes, for example, a liquid crystal display element, a MEMS display element, etc. In the embodiment, the light source unit 11 and the image generation unit 12 are arbitrary. For example, a light emitting display device may be used as the image light generator 10.

For example, an image generator 42 may be provided in the display device 110. The image generator 42 generates the data relating to the image including the display object. The data that is generated by the image generator 42 is supplied to the image generation unit 12. Thereby, the image generation unit 12 generates the image including the display object. The image generator 42 may be provided separately from the holder 60. The communication between the image generator 42 and the image generation unit 12 may be performed by any wired or wireless method.

The light flux 18 including the image is emitted from the image light generator 10. The light flux 18 is incident on the optical unit 20. The light flux 18 that is emitted from the image light generator 10 passes through the optical unit 20. The optical unit 20 includes at least one selected from various light-concentrating elements and various reflecting elements. The optical unit 20 includes, for example, a lens, etc.

The light flux 18 is emitted from the optical unit 20. The light flux 18 is incident on the reflector 30, is reflected by the reflector 30, and is incident on the eye 81.

A virtual image 18v is formed by the reflector 30 based on the light flux 18. In the embodiment, the position where the virtual image 18v is formed is changeable. For example, the light emitter 15 includes a virtual image position controller 15c. The virtual image position controller 15c controls the position of the virtual image 18v formed by the light flux 18 being reflected by the reflector 30. In the example, the virtual image position controller 15c includes a first actuator 10c and a second actuator 20c. The first actuator 10c controls the image light generator 10. For example, the first actuator 10c modifies the position of the image light generator 10. The second actuator 20c controls the optical unit 20. The second actuator 20c modifies, for example, the position of an optical element (at least one selected from a light-concentrating element and a reflecting element) included in the optical unit 20. The actuator may modify the characteristics (at least one selected from the refractive index and the configuration) of the optical element. The actuators include, for example, an ultrasonic motor, a DC motor, etc. The virtual image 18v is formed by the virtual image position controller 15c at multiple positions (e.g., a first position Pv1, a second position Pv2, etc.).

In the embodiment, when performing the display, the display device 110 performs the display by setting the position of the virtual image 18v to the first position Pv1, and subsequently performs the display by setting the position of the virtual image 18v to the second position Pv2.

The first position Pv1 is a position on a line 18L connecting the eye 81 and the background object 71. The second position Pv2 is another position on the line 18L. A second distance Lv2 between the second position Pv2 and the reflector 30 is shorter than a first distance Lv1 between the first position Pv1 and the reflector 30. In other words, the second position Pv2 is more proximal to the reflector 30 than is the first position Pv1.

For example, the virtual image position controller 15c sets the position of the virtual image 18v to the first position Pv1, and subsequently moves the position of the virtual image 18v to the second position Pv2. In the embodiment, the position of the virtual image 18v is moved from the first position Pv1 to the second position Pv2 when displaying one display object. The movement of the position of the virtual image 18v may be continuous or step-like.

For example, the display object that is displayed is perceived to be at the position of the virtual image 18v when viewed by the viewer 80. When viewed by the viewer 80, the display object is displayed first at the first position Pv1 and subsequently at the second position Pv2. When viewed by the viewer 80, for example, the display object appears to approach the second position Pv2 from the first position Pv1. Thereby, an easily-viewable display device can be provided.

For example, there is a reference example in which the position of the virtual image is matched to the position of the image of the background in a HMD. For example, the position of the virtual image is changeable; and when the image of the background is distal, the position of the virtual image is moved away to match the distal image. When the image of the background is proximal, the position of the virtual image is moved closer to match the proximal image. Such a reference example attempts to match the positions of the virtual image and the image of the background. In other words, it is attempted to reduce the incongruity of the superimposition mismatch by disposing the virtual image and the image of the background at the same focal position.

However, it was found from experiments of the inventor that in such a reference example, at least one selected from the image of the background and the image (the display object) of the display becomes difficult to view. When the display object is displayed at the depthward position of the image of the background to be superimposed onto the image of the background, for example, the image of the background is not perceived easily. Or, the display object is not perceived easily.

Conversely, in the embodiment, the position of the virtual image 18v is not fixed. When displaying, the position of the virtual image 18v is moved from the first position Pv1 to the second position Pv2. Thereby, the image of the background object 71 inside the background 70 and the display object perceived at the position of the virtual image 18v are perceived to be separated from each other. Thereby, both the image of the background 70 and the display object can be viewed easily. In the embodiment, an easily-viewable display device can be provided.

For example, the background object 71 of the background 70 is disposed at an object position P01. For example, the first distance Lv1 is not more than an object distance L01 between the background object 71 and the reflector 30.

On the other hand, the second distance Lv2 is, for example, not less than a presettable set-distance L02. The set-distance L02 is set based on a most proximal position P02 viewable by the viewer 80. The set-distance L02 may be set to, for example, the distance between the most proximal viewable position P02 and the reflector 30. The distance between the eye 81 of the viewer 80 and the reflector 30 is, for example, not more than 3 cm. The set-distance L02 is, for example, not less than 20 cm and not more than 50 cm. The set-distance L02 may be set to match the visual characteristics of the viewer 80.

For example, the shortest focal distance at which the viewer 80 can view the image may be used substantially as the second distance Lv2.

For example, in the display device 110, the display object is displayed at the background object position P01 of the background object 71 or at a position (the position of the first distance Lv1) more proximal than the background object position P01; and subsequently, the display object is moved toward the eye 81 to be more proximal. Thereby, an easily-viewable display is possible.

Also, there is a reference example in which the position of the virtual image 18v is set to a position more proximal than that of the background object 71. When displaying in such a case, the position of the virtual image 18v is fixed and is not moved. In such a case, the display is difficult to view.

By displaying the position of the virtual image 18v by moving the position of the virtual image 18v as in the embodiment, the display is easier to view than in the case where the position of the virtual image 18v is fixed.

An example of experimental results relating to the display device will now be described.

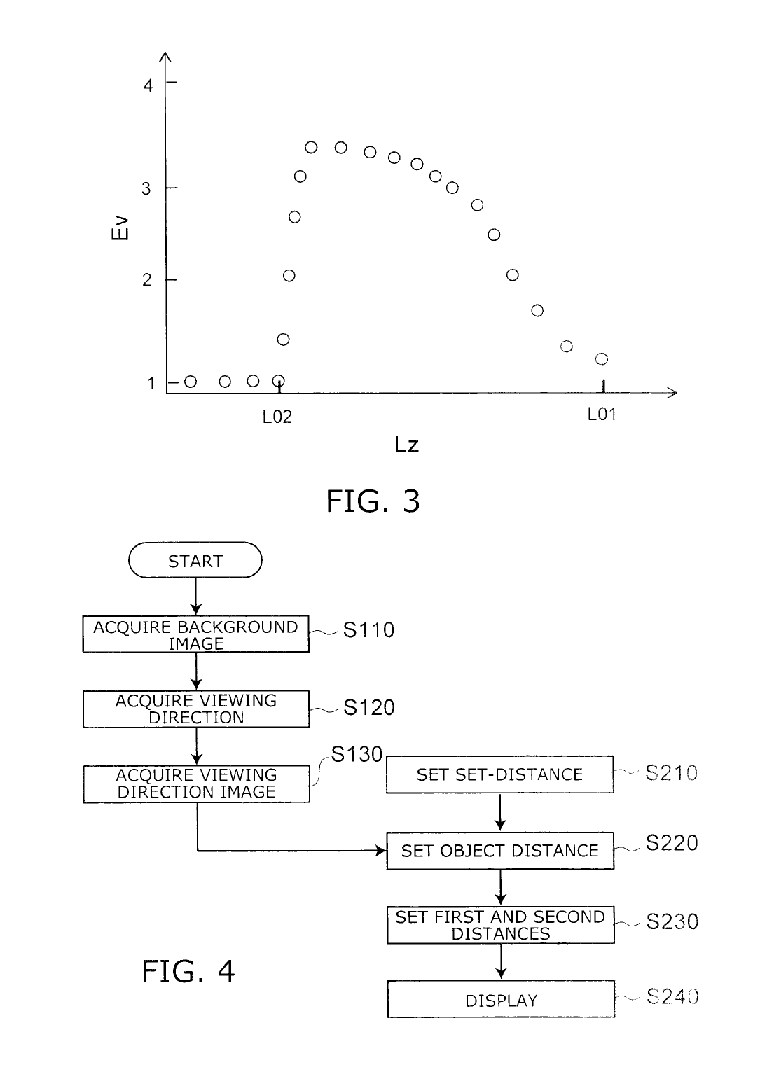

FIG. 3 is a graph illustrating the experimental results relating to the display device.

The horizontal axis of FIG. 3 is a distance Lz from the reflector 30. A large distance Lz corresponds to being distal to the reflector 30. The vertical axis of FIG. 3 is an evaluation value Ev relating to the ease of viewing.

In the experiment, the background object 71 is disposed at the position of the background object distance L01. In the experiment, paper on which characters are written is used as the background object 71. In the example shown in FIG. 3, the background object distance L01 is 8 m. In the example, the set-distance L02 is 30 cm.

The examinee (the viewer 80) views the display object as being superimposed onto the background object 71. The distance Lz between the reflector 30 and the position of the display object (the position of the virtual image 18v) is modified. The examinee evaluates the ease of viewing of the image of the background object 71 and the image of the display object disposed at various distances Lz. Evaluation values of four levels of “1” to “4” are used in the evaluation. The evaluation value Ev is the average of the evaluation values of multiple examinees. A large evaluation value Ev corresponds to being easy to view. An evaluation value Ev of 1 indicates that the display is extremely difficult to view. As seen from FIG. 3, the display is extremely difficult to view when the distance Lz is not more than the set-distance L02 (in this case, 30 cm). In other words, the display object is difficult to view. On the other hand, the display also is difficult to view when the distance Lz is proximal to the background object distance L01. In other words, the display object is displayed to overlap at the position of the background object 71; and the background object 71 and the display object obstruct each other and are difficult to view.

For example, the evaluation value Ev is not less than 2 when the distance Lz is not less than 20 cm and not more than 50 cm. The display is easy to view when the distance Lz is in this range. For example, the evaluation value Ev is not less than 3 when the distance Lz is not less than 50 cm and not more than 250 cm. The display is easier to view when the distance Lz is in this range.

In the embodiment, for example, the first distance Lv1 and the second distance Lv2 may be set to be not less than 20 cm and not more than 50 cm. Thereby, an easily-viewable display is possible. For example, the first distance Lv1 and the second distance Lv2 may be set to be not less than 50 cm and not more than 250 cm. Thereby, a more easily-viewable display is possible.

For example, the first distance Lv1 is not less than 800 cm and not more than infinity. The second distance Lv2 is not less than 50 cm and not more than 250 cm.

In the embodiment, the display object includes the information relating to the background object 71. For example, in the case where the background object is a building, the display object may include information (e.g., character information) of the name of the building. In the case where the background object includes a road, etc., the display object may include information (e.g., character information) including the destination of the road.

The information relating to the background object 71 may be acquired; and the display object may be generated based on the acquired information. For example, in the case where the background object 71 is the building, the information relating to the building is acquired. Based on the information that is acquired, the display object that includes the information relating to the building may be generated.

For example, there are cases where the background object 71 includes character information of a sign, etc. There are cases where the background object 71 is a label, etc., provided on a commodity, etc. In such a case, the information of the sign and/or the label may be acquired; and the display object may be generated based on the acquired information. For example, there are cases where the viewer 80 cannot easily view small characters. In the case where the characters of the background object 71 are small, a display object that corresponds to the characters may be generated and displayed. The small characters that are difficult to view are displayed as enlarged characters. Thereby, the viewer 80 can easily view the characters of the background object 71.

As shown in FIG. 1, the display device 110 may further include the information acquirer 53. The information acquirer acquires the information relating to the image of the background object 71. The information acquirer 53 may include, for example, an imaging device (a camera, etc.). For example, a CCD camera, a CMOS camera, etc., is used as the information acquirer 53.

The image generator 42 generates the data based on the information (e.g., the imaging data) acquired by, for example, the information acquirer 53. The data relates to the image including the display object. The data is supplied to the image generation unit 12; and the image that includes the display object is generated.

For example, in the case where the background object 71 is the sign, etc., the characters (the information) that are written on the sign are imaged by the information acquirer 53. The characters that are written on the sign are estimated by character recognition, etc., based on the imaged data. The estimated characters are used as the display object. The viewer 80 can recognize the characters of the sign by the display object including the characters being displayed.

For example, the display object may include an enlarged image of the image of the background object 71. The viewer 80 recognizes the background object 71 more easily by viewing the enlarged image.

For example, the size of the display object may be the same or different between the first position Pv1 and the second position Pv2.

For example, the size of the display object in the image is substantially the same between when the position of the virtual image 18v is the second position Pv2 and when the position of the virtual image 18v is the first position Pv1. For example, the size of the former is not less than 0.9 times and not more than 1.1 times the size of the latter. In other words, the position of the virtual image 18v approaches the viewer 80 while the size of the display object substantially does not change. The display object of the virtual image 18v is recognized and is easy to view separately from the background object 71 by changing the position of the virtual image 18v.

The size of the display object may be larger when the position of the virtual image 18v is the second position Pv2 than when the position of the virtual image 18v is the first position Pv1. In other words, the position of the display object is moved closer while enlarging the display object. Thereby, for example, the background object 71 is easy to view when the position of the virtual image 18v is the first position Pv1. Then, due to the enlarged display object, the display object is more easily perceived when the position of the virtual image 18v is the second position Pv2.

The size of the display object may be smaller when the position of the virtual image 18v is the second position Pv2 than when the position of the virtual image 18v is the first position Pv1.

As shown in FIG. 1, the sensor 55 and a controller 41 may be provided in the display device 110. The sensor 55 senses the eye gaze 81 of the viewer 80. For example, the sensor 55 images the eye 81 of the viewer 80 and senses the position of the pupil of the eye 81. Thereby, the eye gaze can be sensed. For example, a method utilizing infrared that can measure, for example, eye movement is applicable to the sensor 55. For example, an electro-ocular measurement method that measures the muscle potential around the eye is applicable to the sensor 55.

The controller 41 recognizes (estimates) the background object 71. The background object 71 is positioned in the eye gaze inside the background 70 when the eye 81 is the reference.

The controller 41 recognizes (estimates) the background object 71 based on the eye gaze sensed by the sensor 55. The line 18L connecting the eye 81 and the background object 71 is estimated (recognized) based on the eye 81 and the position of the estimated background object 71. The first position Pv1 and the second position Pv2 are determined by the estimated line 18L.

The controller 41 may estimate the background object distance L01 based on the information acquired by the information acquirer 53 and the background object 71 estimated by the controller 41. For example, the first distance Lv1 is set based on the estimated object distance L01. In other words, for example, the first distance Lv1 is set to be the background object distance L01 or less.

A background object distance sensor 52 may be provided in the display device 110. The background object distance sensor 52 senses the background object distance L01. The background object distance sensor 52 may include, for example, a distance measurement device using an electromagnetic wave such as light (e.g., infrared light), a radio wave, etc. For example, a laser rangefinding method using a laser is applicable to the background object distance sensor 52. For example, a parallax image method utilizing a twin-lens camera is applicable to the background object distance sensor 52. Any non-contact method that can measure the distance is applicable to the background object distance sensor 52.

The first distance Lv1 may be set based on the background object distance L01 sensed by the background object distance sensor 52.

FIG. 4 is a flowchart illustrating the operations of the display device according to the embodiment.

As shown in FIG. 4, the image of the background 70 in front of the viewer 80 is acquired (step S110). For example, this operation is implemented by the information acquirer 53.

The eye gaze 81 of the viewer 80 is acquired (step S120). For example, this operation is performed by the sensor 55.

The eye gaze image is acquired (step S130). In other words, the image of the background object 71 in the eye gaze is acquired.

On the other hand, the set-distance L02 is set (step S210). For example, a value is set according to the visual characteristics of the viewer 80. The set-distance L02 is, for example, not less than 20 cm and not more than 50 cm.

The background object distance L01 is set (step S220) based on the eye gaze image (e.g., the image of the background object 71) acquired in step S130. This operation is performed by the controller 41.

The first distance Lv1 and the second distance Lv2 are set based on the set-distance L02 and the background object distance L01 (step S230). For example, this operation is performed by the controller 41.

The display is performed based on the first distance Lv1 and the second distance Lv2 that are set (step S240). At this time, the virtual image position controller 15c sets the position of the virtual image 18v to the first position Pv1, and subsequently moves the position of the virtual image 18v to the second position Pv2.

Thereby, an easily-viewable display can be implemented.

The display device 110 according to the embodiment is, for example, a HMD mounted to the head of the viewer 80. In the display device 110, for example, the direction (the eye gaze) in which the viewer 80 is viewing is sensed. For example, an image in real space in the eye gaze is imaged. An image (a display object) is displayed based on the image that is imaged. The display distance (the virtual image distance) of the display image is modified.

For example, in a reference example, an image (a display object) of the enlarged image of the background object is displayed at the position of the background object to be superimposed onto the background object of the background. In the reference example, the background and the image (the display object) overlap and are difficult to view. It is difficult to separate the background and the virtual image (the display object).

In the embodiment, the position of the display object (the position of the virtual image 18v) is moved from the first distance Lv1 toward the second distance Lv2. Thereby, it was found that an easily-viewable display is possible.

In the embodiment, the visual adjustment mechanism of the human is induced by hardware control. Thereby, the background 70 is perceived as being out of focus. Thereby, it is easy to perceive the display object relating to the portion (the background object 71 in the eye gaze) of the background 70 to which the viewer 80 desires to pay attention by the display object being separated from the background 70. In other words, both the background 70 and the display object become easy to view.

The operation of the controller 41 may be controlled by software. For example, a background object image acquirer is provided in the software. The background object image acquirer performs matching of the image acquired by the information acquirer 53 and the eye gaze sensed by the sensor 55. The image in the eye gaze inside the acquired image is acquired as an image by the matching.

For example, the set-distance L02 is storable in memory, etc. For example, the shortest focal distance that a human can view is used as the set-distance L02. The standard value of the shortest focal distance is, for example, 25 cm. The set-distance L02 is modifiable according to the viewer 80.

According to the embodiments, an easily-viewable display device can be provided.

Hereinabove, embodiments of the invention are described with reference to specific examples. However, the invention is not limited to these specific examples. For example, one skilled in the art may similarly practice the invention by appropriately selecting specific configurations of components included in the display device such as the image light generator, the light source unit, the image generation unit, the light emitter, the virtual image position controller, the optical unit, the first actuator, the second actuator, the reflector, the controller, the image generator, the background object distance sensor, the information acquirer, the sensor, the holder, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all display devices practicable by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device, comprising:
a light emitter that emits light flux including an image;
a reflector to be in front of an eye of a viewer, the reflector being partially reflective and partially transparent and configured to reflect the light flux toward the eye and form a virtual image;
a virtual image position controller that controls a position of the virtual image; and
a holder that holds the reflector,
wherein the virtual image position controller that sets the position of the virtual image to a first position on a line connecting the eye and a background object in front of the eye and subsequently move the position of the virtual image to a second position on the line that lies closer to the reflector than the first position.

2. The device according to claim 1, wherein a second distance between the second position and the reflector is not less than a set-distance, the set-distance being presettable and being not less than 20 cm and not more than 50 cm.

3. The device according to claim 1, wherein a first distance between the first position and the reflector is not more than a background object distance between the background object and the reflector.

4. The device according to claim 3, further comprising a background object distance sensor that senses the background object distance.

5. The device according to claim 3, further comprising:
an information acquirer that acquires information relating to an image of the background object; and
an image generator that generates the image including a display object relating to the background object based on the information acquired by the information acquirer.

6. The device according to claim 5, further comprising:
a sensor that senses an eye gaze of the eye; and
a controller that estimates the background object based on the eye gaze sensed by the sensor.

7. The device according to claim 6, wherein the controller estimates the background object distance based on the information acquired by the information acquirer.

8. The device according to claim 1, wherein the image includes a display object including information relating to the background object.

9. The device according to claim 1, wherein
the image include a display object, and
a size of the display object in the image when the position of the virtual image is the second position is not less than 0.9 times and not more than 1.1 times a size of the display object in the image when the position of the virtual image is the first position.

10. The device according to claim 1, wherein
the image include a display object, and
a size of the display object in the image when the position of the virtual image is the second position is larger than a size of the display object in the image when the position of the virtual image is the first position.

11. The device according to claim 1, wherein
the image include a display object, and
a size of the display object in the image when the position of the virtual image is the second position is smaller than a size of the display object in the image when the position of the virtual image is the first position.

12. The device according to claim 1, wherein
the light emitter includes an image light generator that emits the light flux, and
the virtual image position controller includes a first actuator that controls the image light generator.

13. The device according to claim 12, wherein the first actuator changes a position of the image light generator.

14. The device according to claim 12, wherein
the light emitter further includes an optical unit that transmits the light flux emitted from the image light generator, and
the virtual image position controller includes a second actuator that controls the optical unit.

15. The device according to claim 14, wherein the second actuator modifies a position of the optical unit.

16. The device according to claim 4, wherein the background object distance sensor senses the background object distance using a distance measurement device using an electromagnetic wave.

17. The device according to claim 6, wherein the sensor measures eye movement of the viewer.

18. The device according to claim 6, wherein the sensor measures a muscle potential around the eye.

19. The device according to claim 14, wherein the second actuator modifies a refractive index of an optical element included in the optical unit.

20. The device according to claim 14, wherein the second actuator modifies a configuration of an optical element included in the optical unit.
